(19) United States
(12) Patent Application Publication
(10) Pub. No.: US 2026/0254020 A1
(43) Pub. Date: Aug. 27, 2026

(54) ALL-SOLID-STATE SECONDARY BATTERY AND METHOD FOR MANUFACTURING SAME

(71) Applicant: Samsung SDI Co., Ltd., Yongin-si, Gyeonggi-do (KR)

(72) Inventors: Minsuk Lee, Yongin-si (KR); Younggyoon Ryu, Yongin-si (KR); Suyeol Ryu, Yongin-si (KR); Jaegu Yoon, Yongin-si (KR); Hongjeong Kim, Yongin-si (KR)

(21) Appl. No.: 18/857,766

(22) PCT Filed: Apr. 14, 2023
(86) PCT No.: PCT/KR2023/005124

§ 371 Date: Oct. 17, 2024

(30) Foreign Application Priority Data
Apr. 20, 2022 (KR) 10-2022-0049101

(51) Int. Cl. H01M 50/24; H01M 10/0562; H01M 10/0585; H01M 50/293; H01M 50/533

(52) U.S. Cl. CPC H01M 50/24; H01M 10/0562; H01M 10/0585; H01M 50/293; H01M 50/533; H01M 2300/0068

(57) ABSTRACT

Provided are an all-solid-state secondary battery and a method of manufacturing the same, the all-solid-state secondary battery comprising: a plurality of battery units each of which includes a cathode layer, a solid electrolyte layer, and an anode layer and which are stacked along a thickness direction; a plurality of buffer layers each of which is disposed between the battery units adjacent to each other; and carrier films each of which connects the buffer layers adjacent to each other.

### TECHNICAL FIELD

The present disclosure relates to an all-solid-state secondary battery and a method of manufacturing the same.

### BACKGROUND ART

Recently, in response to industrial demands, the development of batteries with high energy density and safety has been actively conducted. For example, lithium-ion batteries are being put into practical use not only in the fields of information-related appliances and communication appliances, but also in the field of automobiles. In the field of automobiles, safety is especially important because it involves life.

Lithium-ion batteries currently on the market use electrolytes containing flammable organic solvents, so there is a possibility of overheating and fire in the event of a short circuit. In response to this, all-solid-state secondaries using a solid electrolyte instead of an electrolyte have been proposed.

By not using flammable organic solvents, all-solid-state secondary batteries can greatly reduce the possibility of fire or explosion even if a short circuit occurs. Therefore, these all-solid-state secondary batteries can greatly increase safety as compared with lithium-ion batteries that use electrolytes.

### DISCLOSURE

### Technical Problem

An aspect is to provide an all-solid-state secondary battery including a buffer layer and a method of manufacturing the same.

### Technical Solution

According to an embodiment, there is provided an all-solid-state secondary battery including:
a plurality of battery units each of which includes a cathode layer, a solid electrolyte layer, and an anode layer and which are stacked along a thickness direction;
a plurality of buffer layers each of which is disposed between the battery units adjacent to each other; and
carrier films each of which connects the buffer layers adjacent to each other.

According to another embodiment, there is provided a method of manufacturing an all-solid-state secondary battery, the method including:
preparing battery units each including an anode layer, a solid electrolyte layer, and a cathode layer;
preparing a buffer layer supply member including a plurality of buffer layers arranged in a row and a carrier film connecting the buffer layers adjacent to each other;
sequentially stacking the battery units and the buffer layers included in the buffer layer supply member in a zigzag stacking method.

### Advantageous Effects

According to an all-solid-state secondary battery and a manufacturing method thereof, the all-solid-state secondary battery includes a carrier film connecting buffer layers, so that the transfer speed of the buffer layers can be improved. Accordingly, the stacking difficulty and stacking speed of the buffer layers and the battery units can be improved.

According to an aspect, the all-solid-state secondary battery includes buffer layers, so that it can effectively prevent a short circuit that may occur in the precipitation process of lithium when charging the all-solid-state secondary battery.

### DESCRIPTION OF DRAWINGS

FIG. 1 is a cross-sectional view of an all-solid-state secondary battery according to an embodiment.

FIG. 2 is a cross-sectional view of an all-solid-state secondary battery according to an embodiment.

FIG. 3 is a cross-sectional view of an all-solid-state secondary battery according to an embodiment.

FIG. 4 is a cross-sectional view of a buffer layer supply member according to an embodiment.

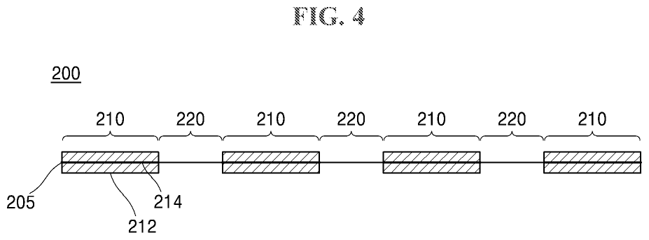

FIG. 5 is a schematic view explaining a zigzag stacking method according to an embodiment.

### MODE FOR INVENTION

There may be provided an all-solid-state secondary battery including: a plurality of battery units each of which includes a cathode layer, a solid electrolyte layer, and an anode layer and which are stacked along a thickness direction; a plurality of buffer layers each of which is disposed between the battery units adjacent to each other; and carrier films each of which connects the buffer layers adjacent to each other.

The all-solid-state secondary battery includes buffer layers, so that it can effectively prevent a short circuit that may occur in the precipitation process of lithium when charging the all-solid-state secondary battery.

In addition, the all-solid-state secondary battery includes a carrier film connecting buffer layers, so that the transfer speed of the buffer layers can be improved, and thus the stacking speed of the buffer layers and the battery units can be improved.

The present inventive concept described below may be subjected to various transformations and may have various embodiments, and specific embodiments are illustrated in the drawings and described in detail. However, this is not intended to limit the present inventive concept to specific embodiments, and should be understood to include all transformations, equivalents, or substitutes included in the technical scope of this present inventive concept.

The terms used below are only used to describe specific embodiments and are not intended to limit the present inventive concept. Singular expressions include plural expressions unless context clearly dictates otherwise. Hereinafter, terms such as “comprise” or “have” are intended to indicate the presence of features, numbers, steps, operations, components, parts, ingredients, materials, or combinations thereof described in the specification, but. It should be understood that these terms do not exclude in advance the presence or addition of one or more other features, numbers, steps, operations, components, parts, components, materials, or combinations thereof, “/” used below may be interpreted as “and” or “or” depending on the situation.

In order to clearly express various layers and areas in the drawings, thicknesses are enlarged or reduced. Throughout the specification, similar parts are given the same reference numerals. Throughout the specification, when a part such as a layer: membrane, region, plate, etc. is said to be “on” or “on” another part, this includes not only the case where it is directly on top of the other part, but also the case where another part is therebetween. Throughout the specification, terms such as first, second, and the like may be used to describe various components, but the components should not be limited by the terms. Terms are used only to distinguish one component from another. In this specification and drawings, components having substantially the same functional configuration are given the same reference numerals, and redundant description is omitted.

Hereinafter, all-solid-state secondary batteries according to example embodiments will be described in more detail.

In this specification, the term “anodeless coating layer for an all-solid-state battery” refers to a coating layer formed on a current collector in an anodeless all-solid-state battery not having an anode active material layer during battery assembly. When an all-solid-state battery having an anodeless coating layer is charged, lithium is absorbed into the anodeless coating layer, and a lithium metal layer is formed between an anode current collector and the anodeless coating layer after the charging capacity of the anodeless coating layer is exceeded.

### [All-Solid-State Secondary Battery 10]

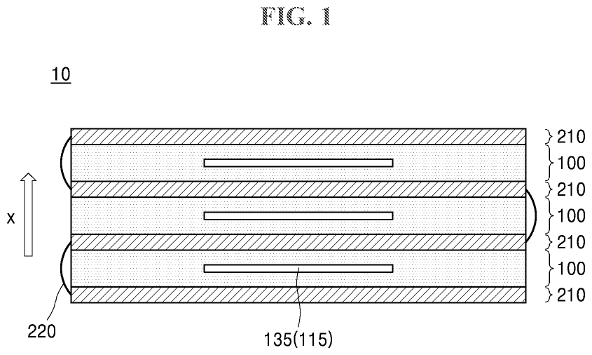

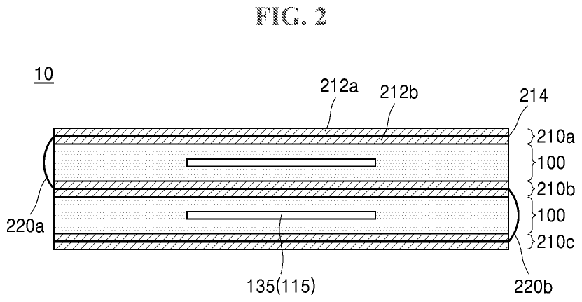

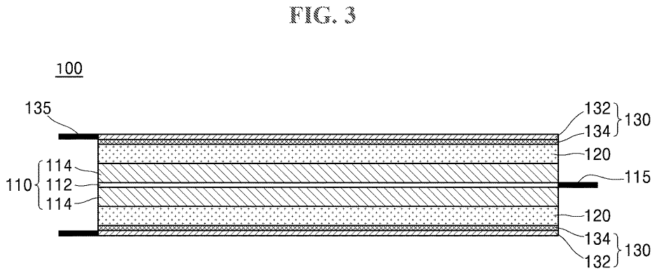

FIGS. 1 and 2 are cross-sectional views of a structure for an all-solid-state secondary battery according to an embodiment. FIG. 3 is a cross-sectional view of a battery unit according to an embodiment.

Referring to FIGS. 1 to 3, the all-solid-state secondary battery 10 may include: a plurality of battery units 100 each of which includes a cathode layer 110, a solid electrolyte layer 120, and an anode layer 130 and which are stacked along a thickness direction X; a plurality of buffer layers 210 disposed between the battery units 100 adjacent to each other; and carrier films 220 each connecting buffer layers 210 adjacent to each other.

According to an embodiment, the thickness of the carrier film 220 may be smaller than the thickness of the buffer layer 210. For example, when the thickness of the carrier film 220 is smaller than the thickness of the buffer layer 210, the volume of the carrier film 220 included in the all-solid-state secondary battery 10 is reduced, so that the energy density of the all-solid-state secondary battery 10 can be increased.

According to another embodiment, the ratio of the thickness of the carrier film 220 to the thickness of the buffer layer 210 may be ½ or less. For example, the ratio of the thickness of the carrier film 220 to the thickness of the buffer layer 210 may be 0.01 to 0.5, 0.02 to 0.5, 0.03 to 0.5, or 0.1 to 0.5 or less.

According to an embodiment, the thickness of the buffer layer 210 may be 10 μm to 500 μm. For example, the thickness of the buffer layer 210 may be 50 μm to 300 μm, greater than 50 μm to less than 300 μm, 60 μm to 290 μm, or 80 μm to 200 μm.

For example, the buffer layer 210 may have a rectangular shape in a plan view, such as a sheet or a plate. The thickness direction X of the buffer layer 210 may coincide with the stacking direction of the battery units 100. When viewed from the stacking direction of the battery units 100, the area of each buffer layer 210 is larger than the area of each battery unit 100, and each buffer layer 210 may be installed to cover the portion of the battery unit 100 except for the cathode tab 115 and the anode tab 135. Additionally, the thickness of each buffer layer 210 may be set so that the total value of the thicknesses of the buffer layers 210 is greater than the total value of the changes in thickness accompanying charging and discharging along the stacking direction of each battery unit 100.

The buffer layer 210 can absorb the volume change (expansion) of the battery unit 100 due to charging and discharging. The buffer layer 210 may be made of members capable of elastic deformation, and more specifically, may be made of a material having a lower elastic modulus than the cathode current collector 112 and the anode current collector 132.

According to an embodiment, the buffer layer 210 may include epoxy resin, acrylic resin, polyimide resin, polyester resin, polypropylene resin, polyamide resin, polystyrene resin, polyvinyl chloride resin, polycarbonate resin, fluorine resin such as PTFE, silicon-based rubber, polyurethane resin, or any combination thereof.

According to another embodiment, the buffer layer 210 may include polyurethane resin, acrylic resin, silicon-based rubber, or any combination thereof.

According to another embodiment, the buffer layer 210 may include polyurethane resin, acrylic resin, rubber, or a combination thereof.

According to an embodiment, the surface microstructure of the buffer layer 210 may have a foam structure, a sponge structure, or a solid structure.

According to an embodiment, the surface microstructure of the buffer layer 210 may have an open cell foam structure, a closed cell foam structure, an open cell sponge structure, a closed cell sponge structure, or a solid structure.

According to some embodiments, the surface microstructure of the buffer layer 210 may have an open cell foam structure, a closed cell foam structure, an open cell sponge structure, or a closed cell sponge structure.

According to another embodiment, the surface microstructure of the buffer layer 210 may have an open cell foam structure or a closed cell foam structure.

According to an embodiment, the carrier film 220 may connect the buffer layers 210 in a zigzag form.

Referring to FIG. 2, the zigzag connected structure may mean a structure in which the first carrier film 220a and the second carrier film 220b are arranged at an intersection by allowing the first carrier film 220a to connect one side of the upper buffer layer 210a and one side of the middle buffer layer 210b and allowing the second carrier film 220b to connect a side opposite to one side of the middle buffer layer 210b and a side opposite to one side of the lower buffer layer 210c when the carrier films 220a and 220b connect the upper buffer layer 210a, the middle buffer layer 210b, and the lower buffer layer 210c. In this case, the zigzag connected structure may include a structure in which a plurality of carrier films 220 are continuously arranged at intersections.

According to an embodiment, each of the carrier films 220 may be attached to one side of each of the buffer layers 210 adjacent to each other to connect buffer layers 210 adjacent to each other.

According to another embodiment, the carrier films 220 may be attached to a carrier layer 214 to be described later to connect the buffer layers 210 adjacent to each other. According to another embodiment, the carrier film 220 may be formed integrally with a carrier layer 214 to be described later to connect the buffer layers adjacent 210 to each other.

According to an embodiment, the buffer layer 210 may include a buffer member layer 212 in contact with the battery unit 100 and a carrier layer 214 connected to the carrier film 220.

According to an embodiment, the buffer member layer 212 may be stacked on one side or both sides of the carrier layer 214.

For example, the buffer member layer 212 may be stacked on one side of the carrier layer 214. For example, the buffer member layers 212 may be stacked on both sides of the carrier layer 214, respectively.

According to an embodiment, the buffer layer 210 may include a structure in which a first buffer layer 212a, a carrier layer 214, and a second buffer layer 212b are sequentially stacked.

According to another embodiment, the buffer member layer 212 may be disposed between the carrier layer 214 and the battery unit 100.

According to another embodiment, the buffer member layer 212 is disposed only in the area between the carrier layer 214 and the battery unit 100, so that, in the outermost buffer layer disposed at the outermost side of the buffer layers 210, the buffer member layer 212 may be disposed only on the side of the carrier layer 214 facing the battery unit 100, and the buffer member layer 212 may not be disposed on a side of the carrier layer 214 opposite to the side facing the battery unit 100. In this case, the all-electric secondary battery 10 may have both a structure in which the buffer member layer 212 is stacked on both sides of the carrier layer 214 and a structure in which the buffer member layer 212 is stacked on one side of the carrier layer 214.

According to an embodiment, the carrier film 220 and the carrier layer 214 may be formed integrally. For example, the carrier layer 214 may be a region of the carrier film 220 where the buffe member layer 212 is disposed on the carrier film 220. For example, the carrier film 220 and the carrier layer 214 are included in a single member, and, in the single member, the region where the buffer member layer 212 is disposed may be defined as the carrier layer 214, and the region where the buffer member layer 212 is not disposed may be defined as the carrier film 220.

According to an embodiment, the carrier film 220 may include epoxy resin, acrylic resin, polyimide resin, polyester resin, polypropylene resin, polyamide resin, polystyrene resin, polyvinyl chloride resin, polycarbonate resin, fluorine resin such as PTFE, silicon-based rubber, polyurethane resin, or any combination thereof.

According to an embodiment, the buffer member layer 212 may have a single-layer structure or a multi-layer structure.

For example, when the buffer member layer 212 has a multi-layer structure, it may include a first layer with excellent resilience and a second layer with excellent buffering power. In this case, the second layer may be adjacent to the battery unit. For example, the first layer and the second layer may be sequentially stacked on the carrier layer 214. For example, the first layer may include polyurethane resin, and the second layer may include acrylic resin.

For example, the buffer member layer 212 may have a single-layer structure. For example, the buffer member layer 212 may include polyurethane resin, acrylic resin, or any combination thereof.

According to an embodiment, a coating layer may not be formed on the surface of the buffer layer 210. For example, when there is no coating layer on the surface of the buffer layer 210, the thickness of the buffer layer 210 is reduced, and thus the energy density of the all-solid-state secondary battery can be improved. In addition, even when a coating layer is not formed on the surface of the buffer layer 210, the buffer layer 210 is transported by the carrier film 220, so a stacking process can be performed more easily.

According to an embodiment, the buffer layer 210 may be disposed adjacent to the anode layer 130 of the battery unit 100. For example, the buffer layer 210 may be disposed adjacent to the anode current collector 132 of the battery unit 100. Accordingly, as the all-solid-state secondary battery is charged, it is possible to effectively prevent a problem of a short circuit occurring in the all-solid-state secondary battery during a process of lithium precipitation in the anode layer 130.

According to an embodiment, an anode layer 130, a solid electrolyte layer 120, and a cathode layer 110 may be sequentially stacked on the buffer layer 210.

According to an embodiment, a cathode layer 100 may be disposed in the central region of the battery unit 100, and a solid electrolyte layer 120 and an anode layer 130 may be sequentially stacked on both sides of the anode layer 100. In this case, the anode layer 130 may be disposed in the outer region of the battery unit 100.

[all-Solid-State Secondary Battery]

FIG. 3 is a cross-sectional view of an all-solid-state secondary battery according to an embodiment.

Referring to FIG. 3, in the all-solid-state secondary battery 100, the cathode layer 110 may include a cathode current collector 112 and a cathode active material layer 114 disposed on one side or both sides of the cathode current collector 112, the anode layer 130 may include an anode current collector 132 and an anodeless coating layer 134 disposed on the anode current collector 132, and the solid electrolyte layer 120 may be disposed between the cathode layer 110 and the anode layer 130.

According to an embodiment, the cathode layer 110 may include cathode active material layers 114 disposed on both sides of the cathode current collector 112, and the solid electrolyte layer 120 and the anode layer 130 may be sequentially stacked on the cathode active material layers 114 disposed on both sides of the cathode current collector 112, respectively. For example, the anode layer 130 may include an anode current collector 132 and an anodeless coating layer 134, and an anodeless coating layer 134 may be disposed between the anode current collector 132 and the solid electrolyte layer 120.

According to an embodiment, the all-solid-state secondary battery 110 may further include a cathode tab 115 extending from the cathode current collector 112 and an anode tab 135 extending from the anode current collector 132, and the cathode tab 115 and the anode tab 135 may be at a skew position with the carrier film.

### [Cathode Layer 110]

### [Cathode Layer 110: Cathode Active Material Layer 114]

The cathode active material layer 114 may include, for example, a cathode active material and a solid electrolyte. For example, the cathode active material may include lithium transition metal oxide.

For example, the solid electrolyte included in the cathode layer 110 may be the same as or different from a solid electrolyte included in the solid electrolyte layer 120 to be described later.

According to an embodiment, the cathode active material may be a cathode active material capable of reversibly absorbing and desorbing lithium ions. For example, the cathode active material may include lithium transition metal oxides such as lithium cobalt oxide (LCO), lithium nickel oxide, lithium nickel cobalt oxide, lithium nickel cobalt aluminum oxide (NCA), lithium nickel cobalt manganese oxide (NCM), lithium manganate and lithium iron phosphate, nickel sulfide, copper sulfide, lithium sulfide, iron oxide, vanadium oxide, or any combination thereof.

According to another embodiment, the cathode active material may include lithium transition metal oxide. For example, the lithium transition metal oxide may include lithium cobalt oxide (LCO), lithium nickel oxide, lithium nickel cobalt oxide, lithium nickel cobalt aluminum oxide (NCA), lithium nickel cobalt manganese oxide (NCM), lithium manganate, lithium iron phosphate, or any combination thereof.

According to an embodiment, the lithium transition metal oxide may be an oxide represented by any one of Formulae of LiₐA_{1-b}B_{b}D₂ (where 0.90≤a≤1, 0≤b≤0.5); LiₐE_{1-b}B_{b}O_{2-c}D_{c} (where 0.90≤a≤1, 0≤b≤0.5, 0≤c≤0.05); LiE_{2-b}B_{b}O_{4-c}D_{c} (where 0≤b≤0.5, 0≤c≤0.05); LiₐN_{1-b-c}Co_{b}B_{c}D_{α} (where 0.90≤a≤1, 0.5≤b≤0.5, 0.5≤c≤0.05, 0<α≤2); LiₐNi_{1-b-c}Co_{b}B_{c}D_{α} (where 0.90≤a≤1, 0≤b≤0.5, 0≤c≤0.05, 0<α<2); LiₐNi_{1-b-c}Co_{b}B_{c}O₂₋ₐF₂ (where 0.90≤a≤1, 0≤b≤0.5, 0≤c≤0.05, 0<α<2); LiₐNi_{2-b-c}Mn_{b}B_{c}D_{α} (where 0.90≤a≤1, 0≤b≤0.5, 0≤c≤0.05, 0<α<2); LiₐNi_{1-b-c}Mn_{b}B_{c}O_{2-α} F_{α} (where 0.90≤a≤1, 0≤b≤0.5, 0≤c≤0.05, 0<α<2); LiₐNi_{1-b-c}Mn_{b}B_{c}O_{2-α}F₂ (where 0.90≤a≤1, 0≤b≤0.5, 0≤c≤0.05, 0<α<2); LiₐNi_{b}E_{c}G_{d}O₂ (where 0.90≤a≤1, 0≤b≤0.9, 0≤c≤0.5, 0.001≤d≤0.1); LiₐNi_{b}Co_{c}Mn_{d}GeO₂ (where 0.90≤a≤1, 0≤b≤0.9, 0≤c≤0.5, 0≤d≤0.5, 0.001≤e≤0.1.); LiₐNiG_{b}O₂ (where 0.90≤a≤1, 0.001≤b≤0.1), LiₐCoG_{b}O₂ (where 0.90≤a≤1, 0.001≤b≤0.1); LiₐMnG_{b}O₂ (where 0.90≤a≤1, 0.001≤b≤0.1); LiₐMn₂G_{b}O₄ (where 0.90≤a≤1, 0.001≤b≤0.1); QO₂; QS₂; LiQS₂; V₂O₅; LiV₂O₃; LiIO₂; LiNiVO₄; Li_{(3-f)}J₂(PO₄)₃ (0≤≤2); Li_{(3-f)}Fe₂(PO₄)₃ (0≤f≤2); and LiFePO₄.

In the lithium transition metal oxide, A may be Ni, Co, Mn, or a combination thereof; B may be Al, Ni, Co, Mn, Cr, Fe, Mg, Sr, V, a rare earth element, or a combination thereof; D may be O, F, S, P, or a combination thereof; E may be Co, Mn, or a combination thereof; F may be F, S, P, or a combination thereof; G may be Al, Cr, Mn, Fe, Mg, La, Ce, Sr, V, or a combination thereof; Q is Ti, Mo, Mn, or a combination thereof; I may be Cr, V, Fe, Sc, Y, or a combination thereof; and J may be V, Cr, Mn, Co, Ni, Cu, or a combination thereof.

For example, the lithium transition metal oxide may further include a coating layer formed on the surface thereof. For example, the lithium transition metal oxide may include both an oxide having a coating layer formed on the surface thereof and an oxide having no coating layer.

According to an embodiment, the coating layer may include a coating element compound such as an oxide of a coating element, a hydroxide of a coating element, an oxyhydroxide of a coating element, an oxycarbonate of a coating element, or a hydroxycarbonate of a coating element.

According to an embodiment, the oxide constituting the coating layer may be amorphous or crystalline. For example, the coating element included in the coating layer may include Mg, Al, Co, K, Na, Ca, Si, Ti, V, Sn, Ge, Ga, B, As, Zr, or any combination thereof.

For example, a method of forming the coating layer may be selected within a range that does not adversely affect the physical properties of a cathode active material. For example, the method of forming the coating layer may include spray coating, dipping, etc.

For example, the cathode active material may include a lithium salt of the transition metal oxide having a layered rock salt type structure among the above-described lithium transition metal oxides. The “layered rock salt type structure” may be, for example, a structure in which oxygen atomic layers and metal atomic layers are arranged alternately and regularly in the <111> direction of a cubic rock salt type structure, and thus each atomic layer form a two-dimensional plane.

The “cubic rock salt type structure” refers to a sodium chloride type (NaCl type) structure, and may refer to a structure in which face centered cubic lattices (FCCs) each being formed by cations and anions are arranged to be offset from each other by ½ of the ridge of a unit lattice. The lithium transition metal oxide having this layered rock salt type structure may be, for example, a ternary lithium transition metal oxide such as LiNiₓCo_{y}Al_{z}O₂ (NCA) or LiNiₓCo_{y}Mn_{z}O₂ (NCM) (0<x<1, 0<y<1, 0<z<1, x+y+z=1). When the cathode active material includes a ternary lithium transition metal oxide having a layered rock salt type structure, the energy density and thermal stability of an all-solid-state secondary battery including the all-solid-state secondary battery structure 10 can be further improved.

For example, the cathode active material may further include a coating layer as described above. According to an embodiment, the coating layer may include Li₂O—ZrO₂ (LZO).

For example, when the cathode active material includes nickel (Ni) as a ternary lithium transition metal oxide such as NCA or NCM, the capacity density of the all-solid-state secondary battery, which will be described later, can be increased, and thus metal elution from the cathode active material in the charged state can be reduced. Accordingly, the cycle characteristics of the all-solid-state secondary battery, which will be described later, can be improved.

According to an embodiment, the shape of the cathode active material may be a particle shape such as a sphere or an elliptical sphere.

### [Cathode Layer: Solid Electrolyte]

According to an embodiment, the cathode active material layer 114 may include a solid electrolyte.

For example, the solid electrolyte included in the cathode layer 110 may be the same as or different from the solid electrolyte included in the solid electrolyte layer 120. For detailed description about the solid electrolyte, refer to the solid electrolyte layer 120 to be described later.

The solid electrolyte included in the cathode active material layer 114 may have a D50 average particle diameter smaller than that of the solid electrolyte included in the solid electrolyte layer 120. For example, the D50 average particle diameter of the solid electrolyte included in the cathode active material layer 114 may be 90% or less, 80% or less, 70% or less, 60% or less, 50% or less, 40% or less, 30% or less, or 20% or less of the D50 average particle diameter of the solid electrolyte included in the solid electrolyte layer 120.

For example, the D50 average particle diameter may be a median particle diameter (D50). The median particle diameter (D50) may refer to, for example, a size of a particle corresponding to 50% of a cumulative volume calculated from the sides of particles having a small particle size in the particle size distribution measured by laser diffraction.

### [Cathode Layer Binder]

According to an embodiment, the cathode active material layer 114 may further include a binder. For example, the binder may include styrene butadiene rubber (SBR), polytetrafluoroethylene, polyvinylidene fluoride, polyethylene, or any combination thereof.

### [Cathode Layer: Conductive Material]

According to an embodiment, the cathode active material layer 114 may further include a conductive material. For example, the conductive material may include graphite, carbon black, acetylene black, Ketjen black, carbon fiber, metal powder, or any combination thereof.

### [Cathode Layer Other Additives]

According to an embodiment, the cathode active material layer 114 may further include additives such as filler, a coating agent, a dispersant, and an ion-conductive auxiliary agent in addition to the above-described cathode active material, solid electrolyte, binder, and conductive material.

For example, as a filler, a coating agent, a dispersant, an ion-conductive auxiliary agent that may be included in the cathode active material layer 114, known materials that are generally used in electrodes of all-solid-state secondary batteries may be used.

### [Cathode Layer: Cathode Current Collector]

According to an embodiment, the cathode current collector 112 may include a plate or foil made of indium (in), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

According to an embodiment, the thickness of the cathode current collector 112 may be, for example, 1 μm to 100 μm, 1 μm to 50 μm, 5 μm to 25 μm, or 10 μm to 20 μm.

### [Solid Electrolyte Layer]

### [Solid Electrolyte Layer Solid Electrolyte]

According to an embodiment, the solid electrolyte layer 120 may include a solid electrolyte.

According to an embodiment, the solid electrolyte may include a sulfide-based solid electrolyte. For example, the sulfide-based solid electrolyte may include Li₂S—P₂S₅, Li₂S—P₂S₅—LiX (X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₅, Li₂S—P₂S₅—ZₘSₙ (m and n are positive numbers, Z is one of Ge, Zn, and Ga), Li₂S—GeS₂, Li₂S—SiS₂—Li₃PO₄, Li₂S—SiS₂-LiₚMO_{q} (p and q are positive numbers, M is one of P, Si, Ge, B, Al, Ga, and In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), or any combination thereof.

According to another embodiment, the sulfide-based solid electrolyte may be produced by processing a starting material such as Li₂S, P₂S₅, or the like by melting quenching or mechanical milling. Additionally, after this processing, heat treatment may be performed.

According to an embodiment, the solid electrolyte may be amorphous, crystalline, or any combination thereof. For example, the solid electrolyte may be a solid electrolyte including sulfur (S), phosphorus (P), and lithium (Li) as constituent elements in the above-described sulfide-based solid electrolyte material.

For example, the solid electrolyte layer 120 may include Li₂S—P₂S₅ as a sulfide-based solid electrolyte material. When a sulfide-based solid electrolyte material including Li₂S—P₂S₅ is used to form the solid electrolyte, the mixing molar ratio of Li₂S and P₂S₅ may be Li₂S:P₂S₅=50:50 to 90:10.

For example, the sulfide-based solid electrolyte may include an argyrodite type solid electrolyte represented by Formula 1 below:

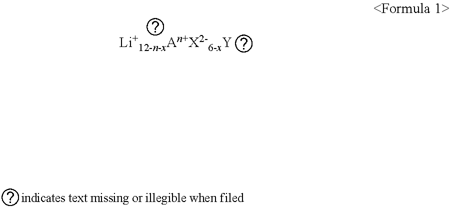

wherein A is P, As, Ge, Ga, Sb, Si, Sn, Al, In, Ti, V, Nb or Ta, X is S, Se or Te, and Y is Cl, Br, I, F, CN, OCN, SCN, or N3, and 1≤n≤5, 0≤x≤2.

The sulfide-based solid electrolyte may be, for example, an argyrodite-type compound including one or more selected from Li₇₋ₓPS₆₋ₓClₓ (0≤x≤2), Li₇₋ₓPS₆₋ₓBrₓ (0≤x≤2), and Li₇₋ₓPS₆₋ₓIₓ (0≤x≤2). The sulfide-based solid electrolyte may be, for example, an argyrodite-type compound including one or more selected from Li₆PS₅Cl, Li₆PS₅Br, and Li₆PS₅I.

The density of the argyrodite-type solid electrolyte may be 1.5 to 2.0 g/cc. Since the argyrodite-type solid electrolyte has a density of 1.5 g/cc or more, the internal resistance of an all-solid-state secondary battery can be reduced, and the penetration of a solid electrolyte layer by Li can be effectively suppressed.

### [Solid Electrolyte Layer: Binder]

According to an embodiment, the solid electrolyte layer 120 may include a binder. For example, the binder included in the solid electrolyte layer 120 may include, for example, styrene butadiene rubber (SBR), polytetrafluoroethylene, polyvinylidene fluoride, polyethylene, or any combination of thereof.

For example, the binder included in the solid electrolyte layer 120 may be the same as or different from the binder included in the above-described cathode active material layer 114 and the anode layer 130 to be described later.

The amount of the binder included in the solid electrolyte layer 120 may be 0 wt % to 10 wt %, 0 wt % to 5 wt %, 0 wt % to 3 wt %, 0 wt % to 1 wt %, 0 wt % to 0.5 wt %, or 0 wt % to 0.1 wt %.

### [Anode Layer]

Referring to FIG. 3, the anode 130 may include an anode current collector 132 and an anodeless coating layer 134.

According to an embodiment, the anode current collector 132 may be made of a material that does not react with lithium, that is, does not form any alloy or compound.

For example, the material constituting the anode current collector 132 may be, for example, copper (Cu), stainless steel, titanium (Ti), iron (Fe), cobalt (Co), nickel (Ni), or any combination thereof. For example, the anode current collector 132 may be formed in a plate shape or a foil shape.

For example, a thin film may be formed on the surface of the anode current collector 132. The thin film may include an element capable of forming an alloy with lithium. The element capable of forming an alloy with lithium may include, for example, gold, silver, zinc, tin, indium, silicon, aluminum, bismuth, or any combination thereof. For example, due to the thin film, the precipitation form of a metal layer to be described later can be further flattened, and thus the characteristics of the all-solid-state secondary battery 100 can be further improved.

According to an embodiment, the thin film may be disposed between the anode current collector 132 and the anodeless coating layer 134. The thickness of the thin film may be 1 nm to 500 nm.

According to an embodiment, the thin film may be formed on the anode current collector 132 by vacuum deposition, sputtering, plating, etc.

According to an embodiment, the anodeless coating layer 134 includes an anode active material and a binder, and can be stabilized on the anode current collector.

According to an embodiment, the anodeless coating layer 134 may include an anode active material that forms an alloy or compound with lithium.

According to an embodiment, the anode active material may include amorphous carbon, gold (Au), platinum (Pt), palladium (Pd), silicon (Si), silver (Ag), aluminum (Al), bismuth (Bi), tin (Sn), zinc (Zn), or any combination thereof.

For example, the amorphous carbon may include carbon black (CB), acetylene black (AB), furnace black (FB), ketjen black (KB), graphene or any combination thereof.

According to another embodiment, the anodeless coating layer 134 may include only amorphous carbon as an anode active material, or may also include at least one metal selected from the group consisting of gold, platinum, palladium, silicon, silver, aluminum, bismuth, tin, and zinc as an anode active material.

According to another embodiment, the anodeless coating layer 134 may include amorphous carbon; and at least one metal selected from the group consisting of gold, platinum, palladium, silicon, silver, aluminum, bismuth, tin, and zinc.

According to an embodiment, the weight ratio of the amorphous carbon and the metal may be, for example, 10:1 to 1:2. For example, when the anode active material includes the amorphous carbon and the metal to satisfy the above range, the characteristics of the all-solid-state secondary battery 100 may be further improved.

According to another embodiment, the weight ratio of the amorphous carbon and the metal may be, for example, 3:1 to 1:1.

According to and embodiment, when the anode active material includes at least one metal from gold, platinum, palladium, silicon, silver, aluminum, bismuth, tin, and zinc, the particle size (e.g., average particle diameter (D50)) of the anode active material may be about 4 μm or less. For example, when the particle size of the anode active material satisfies the above range, the characteristics of the all-solid-state secondary battery 100 may be further improved. According to an embodiment, the particle size of the anode active material may be about 10 nm or more.

Here, the particle size of the anode active material may be, for example, a median diameter (so-called D50) measured using a laser-type particle size distribution meter.

According to an embodiment, the anode active material may have a form of particles, and the average particle diameter of the anode active material may be about 1 to 3 μm.

According to an embodiment, the anode active material may include a mixture of first particles formed of amorphous carbon and second particles formed of metal or semiconductor. The metal or semiconductor may include, for example, gold, platinum, palladium, silicon, silver, aluminum, bismuth, tin, zinc, etc. Here, the amount of the second particles may be about 8 to 60 wt % or about 10 to 50 wt % based on the total weight of the mixture.

According to an embodiment, when the anode active material contains silicon, the silicon may become amorphous after initial charging and discharging.

According to an embodiment, the anode active material may include a mixture of amorphous carbon and silicon (Si) or a mixture of amorphous carbon and silver (Ag).

The anode active material may include a mixture of first particles formed of amorphous carbon and second particles formed of metal or semiconductor, and the amount of the second particles may be 8 parts by weight to 60 parts by weight, for example, 10 parts by weight to 70 parts by weight, for example, 15 parts by weight to 60 parts by weight, based on 100 parts by weight of the total weight of the mixture. According to an embodiment, the binder may include a conductive binder. For example, the conductive binder can stabilize the anodeless coating layer 134 on the anode current collector 132 and can improve resistance characteristics.

According to an embodiment, the conductive binder may include a block copolymer containing a conductive domain and a non-conductive domain.

For example, the conductive domain of the block copolymer may be a region responsible for ionic conductivity and/or electronic conductivity of the block copolymer, and the non-conductive domain may be a region related to the mechanical properties of the block copolymer.

In the block copolymer according to an embodiment, the conductive domain may include a polymer containing an ion-conductive repeating unit, a mixture of a polymer containing an ion-conductive repeating unit and a crosslinked network phase, a polymer containing an electron-conductive repeating unit, or any combination thereof.

According to an embodiment, the polymer containing the ion-conductive repeating unit may be one or more selected from polyethylene oxide, polysilsesquioxane, poly(ethylene glycol)methyl ether methacrylate (POEM), polysiloxane, polypropylene oxide, polymethyl methacrylate, polyethyl methacrylate, polydimethylsiloxane, polyacrylic acid, polymethacrylic acid, polymethyl acrylate, polyethyl acrylate, poly2-ethylhexyl acrylate, polybutyl methacrylate, poly2-ethylhexyl methacrylate, polydecyl acrylate, polyethylene vinyl acetate, polyimide, polyamine, polyamide, polyalkyl carbonate, polynitrile, and polyphosphazines.

According to an embodiment, in the block copolymer including a mixture of a polymer containing an ion-conductive repeating unit and a crosslinked network phase, the crosslinked network phase is obtained by the reaction of a crosslinkable reactive group-containing compound, and includes a product obtained by the chemical bond of the crosslinkable reactive group-containing compound. For example, the chemical bond may refer to a covalent bond. For example, the polymer containing an ion-conductive repeating unit and the crosslinked network phase may be physically bonded. Here, being physically bonded may refer to being connected through a non-covalent bond.

According to an embodiment, the crosslinkable reactive group-containing compound may include one or more selected from a multifunctional polymerizable monomer having a crosslinkable reactive group, an inorganic particle having a crosslinkable reactive group, and an ionic liquid having a crosslinkable reactive group. For example, the crosslinked network phase may include a reaction product of the above-described crosslinkable reactive group-containing compound.

According to an embodiment, the crosslinkable reactive group-containing compound may include at least one unit selected from a lithium ion-conductive unit and a hydrophilic unit. For example, when the crosslinkable reactive group-containing compound includes the unit, at the time of preparing an electrolyte, a crosslinking reaction of a crosslinkable reactive group-containing compound may proceed in an ion conductive domain to form a block copolymer having an ion-conductive domain including a crosslinked network phase and an electrolyte containing the same.

According to an embodiment, the multifunctional polymerizable monomer having a crosslinkable reactive group may include one or more selected from polyethylene glycol diacrylate, polyethylene glycol dimethacrylate, ethoxylated trimethylolpropane triacrylate, ethoxylated trimethylolpropane trimethacrylate, 1,4-butadane, 1,6-hexadiene, allyl acrylate, acrylated cinnamate, isoprene, butadiene, chloroprene, 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethylene glycol (meth)acrylate, 2-hydroxypropylene glycol (meth)acrylate, acrylic acid, methacrylic acid, 2-(meth)acryloyloxy acetic acid, 3-(meth)acryloyloxy propionic acid, 4-(meth)acryloyloxy butyric acid, itaconic acid, maleic acid, 2-isocyanatoethyl (meth)acrylate, 3-isocyanatopropyl (meth)acrylate, 4-isocyanatobutyl (meth)acrylate, (meth)acrylamide, N-vinyl pyrrolidone, ethylenedimethacrylate, diethylene glycol methacrylate, triethylene glycol dimethacrylate, trimethylene propane trimethacrylate, trimethylene propane triacrylate, 1,3-butanediol methacrylate, 1,6-hexanediol dimethacrylate, and N-vinyl caprolactam.

According to an embodiment, the block copolymer including a mixture of a polymer containing an ion-conductive repeating unit and a crosslinked network phase may include 1) a block copolymer containing a first block of polystyrene and a second block including polyethylene oxide and one reaction product selected from polyethylene glycol diacrylate and polyethylene glycol dimethacrylate; ii) a block copolymer containing a first block of polystyrene, a second block including polyethylene oxide and one reaction product selected from polyethylene glycol diacrylate and polyethylene glycol dimethacrylate, and a third block of polystyrene; or any combination thereof.

For example, the polymer including an electron-conductive repeating unit may include one or more selected from polyaniline (PANI), polypyrrole (PPy), poly(3,4-ethylenedioxythiophene) (PEDOT), and poly(3,4-ethylenedioxythiophene): poly(styrenesulfonate) (PEDOT:PSS).

For example, the non-conductive domain is a region responsible for mechanical properties in a block copolymer, and may include a structural domain, a rubbery domain, an olefin domain, a structural domain having an organic-inorganic silicon structure, or any combination thereof.

In the block copolymer according to an embodiment, the structural domain may include a structural block including a plurality of structural repeating units, and the structural block may include a polymer including the structural repeating units. The polymer including the structural repeating units may be i) one or more selected from polystyrene, hydrogenated polystyrene, polymethacrylate, poly(methyl methacrylate), polyvinylpyridine, polyvinylcyclohexane, polyimide, polyamide, polyethylene, polyisobutylene, polybutylene, polypropylene, poly(4-methyl pentene-1), poly(butylene terephthalate), poly(isobutyl methacrylate), poly(ethylene terephthalate), polydimethylsiloxane, polyacrylonitrile, polyvinylcyclohexane, polymaleic acid, polymaleic anhydride, polymethacrylic acid, poly(tertbutyl vinyl ether), poly(cyclohexyl methacrylate), poly(cyclohexyl vinyl ether), poly(tertbutyl vinyl ether), polyvinylidene fluoride, and poly divinylbenzene, or may include II) a copolymer including two or more types of repeating units constituting the above-described polymer.

According to an embodiment, the rubbery domain has excellent properties in all of strength, ductility, and elasticity, and may include a rubbery block including a plurality of rubbery repeating units. For example, the rubbery block may include one or more selected from the group consisting of polyisoprene, polybutadiene, polychloroprene, polyisobutylene, and polyurethane.

According to an embodiment, the block copolymer having the rubbery domain may include, for example, a block copolymer including a first block of polystyrene and a second block of polyisoprene, a block copolymer including a first block of polystyrene, a second block of polyisoprene, and a third block of polystyrene, a block copolymer including a first block of polystyrene and a second block of polybutadiene, a block copolymer including a first block of polystyrene, a second block of polybutadiene, and a third block of polystyrene, or any combination thereof.

According to an embodiment, the olefin domain is a non-conductive region, and may contribute to mechanical properties such as tensile strength. For example, the olefin domain may include an olefin block including a plurality of olefin repeating units, and the olefin block may include a polymer including olefin repeating units. For example, the polymer including the olefinic repeating unit may include one or more selected from the group consisting of polyethylene, polybutylene, polyisobutylene, and polypropylene. For example, the block copolymer having the olefinic domain may include polyethylene oxide-polypropylene block copolymer, a polyethylene oxide-polypropylene block copolymer, or any combination thereof.

According to an embodiment, the structural domain having the organic-inorganic silicon structure may be involved in the strength and mechanical properties of the anodeless coating layer. For example, the organic-inorganic silicon structure may include a compound represented by Formula 1 below.

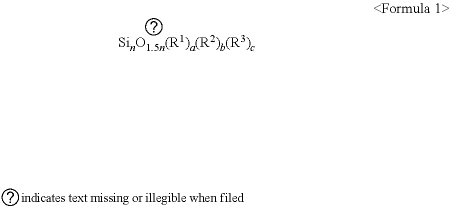

in Formula 1,
n=a+b+c, 6≤n≤20, and
R¹, R², and R³ are independently a hydrogen atom, an organic functional group, a silicon functional group, or a combination thereof.

According to an embodiment, the mixing weight ratio of the conductive domain and the non-conductive domain in the block copolymer may be 1:99 to 99:1, for example, 10:90 to 90:10, for example, 20:85 to 15:80, for example, 50 to 80 parts by weight.

According to an embodiment, when the block copolymer is a block copolymer including an ion conductive domain and a structural domain, the amount of the ion conductive domain may be 55 parts by weight to 80 parts by weight based on 100 parts by weight of the total weight of the block copolymer. For example, when the amount of the ion conductive domain satisfies the above range, the lithium-ion conductivity of the anodeless coating layer can be improved, and thus the movement characteristics of lithium ions to the cathode during discharging can be further improved.

For example, the block copolymer including the ion conductive domain and the structural domain may include a block copolymer including a first block of polystyrene and a second block including polyethylene oxide; a block copolymer including a first block of polystyrene, a second block including polyethylene oxide, and a third block of polystyrene; a block copolymer including a first block of polystyrene and a second block including polysilsesquioxane; a block copolymer including a first block of polystyrene, a second block containing polysilsesquioxane, and a third block of polystyrene; a block copolymer including a first block of polystyrene and a second block including poly(ethylene glycol)methyl ether methacrylate (POEM); a block copolymer including a first block of polystyrene, a second block including POEM, and a third block of polystyrene; a block copolymer including a first block of polystyrene and a second block including polysiloxane; a block copolymer including a first block of polystyrene, a second block including polysiloxane, and a third block of polystyrene; or any combination thereof.

According to an embodiment, the anodeless coating layer 310 may include a second binder such as styrene butadiene rubber (SBR), polytetrafluoroethylene, polyvinylidene fluoride, or polyethylene in addition to the above-described block copolymer, as the conductive binder. The amount of the second binder may be 1 parts by weight to 30 parts by weight based on 100 parts by weight of the total weight of the binder.

According to an embodiment, the anodeless coating layer 310 may be produced by applying an anode slurry, in which a material constituting the anodeless coating layer is dispersed, on an anode current collector and drying the anode slurry.

According to an embodiment, when the anode slurry is applied on the anode current collector 320 by a screen printing method, clogging of a screen (for example, clogging by aggregates of an anode active material) can be suppressed. For example, when using the conductive binder, dispersibility is improved as compared with when using a non-conductive binder such as polyvinylidene fluoride, and thus slurry production process time can be shortened.

According to an embodiment, the amount of the binder may be 0.3 parts by weight to 15 parts by weight, for example, 1 part by weight to 10 parts by weight, based on 100 parts by weight of the total weight of the anode active material.

According to an embodiment, the thickness of the anodeless coating layer 134 may be 1 μm to 20 μm.

For example, the thickness of the anodeless coating layer 134 may be, for example, 1 μm to 10 μm. For example, when the thickness of the anodeless coating layer 134 satisfies the above range, the performance of the all-solid-state battery can be further improved.

According to another embodiment, additives used in general solid batteries, such as a filler, a dispersant, and an ion-conductive agent, may be appropriately mixed in the anodeless coating layer 134.

According to another embodiment, the all-solid-state secondary battery 100 may further include a metal layer (not shown) disposed between the anode current collector 132 and the anodeless coating layer 134, and the metal layer (not shown) may include lithium or a lithium alloy. The metal layer (not shown) may be formed between the anode current collector and the anodeless coating layer before charging.

In this case, the metal layer (not shown) may be prepared in advance. For example, since the metal layer functions as a lithium reservoir, the characteristics of the all-solid-state secondary battery 100 can be further improved. The thickness of the metal layer may be about 1 μm to 200 μm.

According to an embodiment, the anode current collector 132, the anodeless coating layer 134, and the area therebetween may be a Li-free region that does not contain lithium (Li) in the initial state or post-discharge state of the all-solid-state secondary battery 100.

When the all-solid-state secondary battery 100 according to this embodiment is charged, lithium may be stored in the anodeless coating layer 134 at the beginning of charging. That is, the anode active material may form an alloy or compound with lithium ions that have migrated from the cathode layer 110. When the all-solid-state secondary battery 100 is charged beyond the capacity of the anodeless coating layer 134, lithium is precipitated on the back side of the anodeless coating layer 134, that is, between the anode current collector 132 and the anodeless coating layer 134, and thus a metal layer (not shown) is formed by this lithium. The metal layer may be made primarily of lithium (i.e., metallic lithium). This phenomenon may occur by using a specific material, that is, a material forming an alloy or compound with lithium, as the anode active material.

During discharging, lithium in the anodeless coating layer 134 and the metal layer (not shown) is ionized and moves toward the cathode 100. Therefore, lithium may be used as the anode active material in the all-solid-state secondary battery 100. Additionally, since the anodeless coating layer 134 covers the metal layer, the anodeless coating layer 134 may serve as a protective layer for the metal layer and may suppress the precipitation growth of dendrites. This may serve to suppress the short circuit and capacity reduction of the all-solid-state secondary battery 100 and further improve the characteristics of the all-solid-state secondary battery 100.

The all-solid-state battery may be a lithium battery, for example, a lithium secondary battery. Further, the all-solid-state battery according to an embodiment may be an all-solid-state secondary battery.

As described above, the all-solid-state secondary battery according to this embodiment may be applied to various portable devices, vehicles, etc.

[Manufacturing of all-Solid-State Secondary Battery]

A method of manufacturing an all-solid-state secondary battery according to an embodiment of the present disclosure may include: preparing a battery unit 100 including an anode layer 110, a solid electrolyte layer 120, and a cathode layer 130; preparing a buffer layer supply member 200 including a plurality of buffer layers 210 arranged in a row and a carrier film 220 connecting the buffer layers 210 adjacent to each other; and sequentially stacking the battery units 100 and the buffer layers 210 included in the buffer layer supply member 200 in a zigzag stacking method

### [Manufacturing of Battery Unit]

### (Manufacturing of Laminate of Solid Electrolyte Layer/Anode Layer)

### (Manufacturing of Anode Layer)

The anode layer 130 may be manufactured in a wet method in the same method as a conventional method of manufacturing the anode layer 130. For example, an anode active material, a conductive material, a binder, and a solvent are mixed to prepare an anode slurry. The anode slurry may be applied on an anode current collector and drying the slurry to prepare an anode layer 130. The solvent used in the manufacturing of the anode slurry is not particularly limited, and any solvent used in the anode slurry in the art is possible. The solvent used in the anode slurry is, for example, NMP. For the types and amounts of the anode current collector, anode active material, conductive material, and binder, refer to those of the above-described anode layer 130.

Alternatively, the anode slurry may be applied on a laminate in which a lithium metal layer is stacked on one side of the anode current collector 132 and then dried to prepare the anode layer 130

### (Manufacturing of Solid Electrolyte Layer)

Subsequently, a solid electrolyte layer 120 may be directly formed on the anode layer 130. For example, the solid electrolyte layer 120 including a solid electrolyte may be manufactured by applying a precursor of a solid electrolyte material onto the anode layer 130 and then heat-treating the precursor. The solid electrolyte layer 120 including a sulfide-based solid electrolyte may be manufactured by applying a precursor of a sulfide-based solid electrolyte material onto the anode layer 130 and then heat-treating the precursor.

The sulfide-based solid electrolyte may be produced by contacting precursors in stoichiometric amounts to form a mixture and heat-treating the mixture. The contacting may include, for example, milling such as ball milling or pulverizing. The mixture in which precursors are mixed with a stoichiometric composition may be subjected to primary heat treatment in an oxidizing atmosphere to prepare a primary heat treatment resultant. The primary heat treatment may be performed for 1 hour to 36 hours at a temperature range of less than 1000° C. The primary heat treatment resultant may be pulverized. The pulverization of the primary heat treatment resultant may be performed by a dry or wet method. The wet pulverization may be performed, for example, by mixing the primary heat treatment resultant with a solvent such as methanol and then milling the mixture using a ball mill or the like for 0.5 hours to 10 hours. The dry pulverization may be performed by milling with a ball mill or the like without a solvent. The particle size of the pulverized primary heat treatment resultant may be 0.1 μm to 10 μm, or 0.1 μm to 5 μm. The pulverized primary heat treatment resultant may be dried. The pulverized primary heat treatment resultant may be mixed with a binder solution and molded into a pellet form, or may simply be pressed at a pressure of 1 to 10 tons and formed into a pellet form.

The molding product may be subjected to secondary heat treatment at a temperature of less than 1000° C. for 1 hour to 36 hours. A solid electrolyte layer 120, which is a sintered product, may be obtained by secondary heat treatment. The secondary heat treatment may be performed at, for example, 550° C. to 1000° C. The primary heat treatment is performed for 1 hour to 36 hours. To obtain a sintered product, the secondary heat treatment temperature is higher than the primary heat treatment temperature. For example, the secondary heat treatment temperature may be higher than the primary heat treatment temperature by 10° C., or more, 20° C., or more, 30° C. or more, or 50° C., or more. The molded product may be subjected to secondary heat treatment in one or more of an oxidizing atmosphere and a reducing atmosphere. The secondary heat treatment may be performed in a) an oxidizing atmosphere, b) a reducing atmosphere, or c) an oxidizing atmosphere and a reducing atmosphere.

Next, an anode layer 130 is disposed on the solid electrolyte layer 120 and pressed to prepare a laminate of the solid electrolyte layer 30/anode layer 20. Alternatively, a Li/Cu laminate in which a lithium metal layer is stacked on one side of the anode current collector 132 may be disposed on the first laminate, and a second anode active material layer, which is a lithium metal layer, may be disposed between the anode current collector 132 and the solid electrolyte layer 30.

The pressing includes, for example, roll pressing, flat pressing, warm isotactic pressing (WIP), cold isotactic pressing (CIP), and the like, but is not necessarily limited to these methods. Any pressing used in the related technical field is possible. The pressure applied during pressing is, for example: 50 MPa to 500 MPa. The time for which the pressure is applied is, for example, 0.1 min to 30 min. The pressing is performed, for example, at a temperature from room temperature to 90° C., or more, and at a temperature from 20° C. to 90° C. Alternatively, the pressing may be performed at a high temperatures of 100° C., or more. The pressing process may be omitted.

### (Manufacturing of Cathode Layer)

A cathode active material, which is a material constituting a cathode active material layer 114, a conductive material, and a binder are added to a solvent to prepare a cathode active material slurry. The prepared slurry is applied onto a cathode current collector and dried. The obtained laminate is pressed to manufacture a cathode layer 110. The pressing includes, for example, roll pressing, flat pressing, press using hydrostatic pressure, and the like, but is not necessarily limited to these methods. Any pressing used in the related technical field is possible. The pressing process may be omitted. The cathode layer 110 may be manufactured by compacting and molding a mixture of materials constituting the cathode active material layer 114 into a pellet form or stretching (molding) the mixture into a sheet form.

Before placing the cathode layer on the solid electrolyte layer, the surface of the cathode active material layer included in the cathode layer may be impregnated with a liquid electrolyte and then used

### (Manufacturing of Battery Unit)

The cathode layer 110 and the laminate of the anode layer 130, and solid electrolyte layer 120, which were manufactured by the above-described method, are stacked to have the solid electrolyte layer 120 between the cathode layer 110 and the anode layer 130, and pressed, thereby manufacturing a battery unit 100.

For example, the laminate of the anode layer 130/solid electrolyte layer 120 may be disposed on one or both sides of the cathode layer 110 such that the cathode layer 110 and the solid electrolyte layer 120 are in contact with each other to form a second laminate, and the second laminate may be pressed, thereby manufacturing the battery unit 100.

For example, the laminates of the anode layer 130/solid electrolyte layer 120 may be disposed on both sides of the cathode layer 110, respectively, such that the cathode layer 110 and the solid electrolyte layer 120 are in contact with each other to form a second laminate, and the second laminate may be pressed, thereby manufacturing the battery unit 100.

The press includes, for example, roll pressing, flat pressing, pressing using hydrostatic pressure, and the like, but is not necessarily limited to these methods. Any pressing used in the related technical field is possible. The pressure applied during pressing is, for example, 50 MPa to 750 MPa or 300 MPa to 600 MPa. The time for which the pressure is applied is, for example, 0.1 min to 120 min or 10 min to 60 min. The pressing is performed, for example, at a temperature from room temperature to 100° C. or more, or from 20° C. to 100° C. Alternatively, the pressing may be performed at a high temperature of 100° C., or more. The configuration and manufacturing method of the all-solid-state secondary battery 10 described above is an example of the embodiment, and the structural members and manufacturing procedures thereof may be appropriately changed. The pressing process may be omitted.

According to an embodiment, the battery unit 100 may be manufactured by stacking the solid electrolyte layer 120 and the anode layer 120 on one or both sides of the cathode layer 110 to form a laminate and sealing the laminate with an exterior material. In this case, the above-described cathode tab 115 and anode tab 135 may protrude outside the exterior material

### (Manufacturing of Buffer Layer Supply Member)

According to an embodiment, a buffer layer supply member 200 including a plurality of buffer layers 210 arranged in a row and carrier films 220 each connecting the buffer layers 210 adjacent to each other may be prepared.

According to an embodiment, the buffer layer supply member 200 may include buffer member layers 212 disposed at regular intervals on one or both sides of a carrier member 205 to be spaced apart from each other. For example, the buffer layer supply member 200 may be prepared by disposing the buffer member layer 212 on one side or both sides of the carrier member 205. In this case, the region of the carrier member 205 where the buffer member layer 212 is disposed may be defined as a carrier layer 214. Further, the region of the carrier member 205 where the buffer member layer 212 is not disposed may be defined as a carrier film 214.

The surface microstructure of the buffer member layer 212 may have, for example, an open/closed cell foam structure or an open/closed cell sponge structure. For example, since the buffer member layer 212 has adhesiveness, the buffer member layer 212 can be easily attached directly to one or both sides of the carrier film 220. Alternatively, a binder may be additionally disposed between the carrier film 220 and the buffer member layer 212 to improve adhesion. The binder may be the same as the binder used in the cathode layer, anode layer, and/or solid electrolyte layer.

For example, more detailed description about the structure, material, and physical properties of the buffer layer 210, the carrier film 220, the buffer member layer 212, and the carrier layer 214 may be referred to the above description.

(Manufacturing of all-Solid-State Secondary Battery)

An all-solid-state secondary battery may be manufactured as follows, for example.

First, a battery unit 100 including a cathode layer 110, an anode layer 130, and a solid electrolyte layer 120 is prepared.

Then, a buffer layer supply member 200 including a plurality of buffer layers 210 arranged in a row and carrier films 220 each connecting the buffer layers 210 adjacent to each other is prepared.

Subsequently, the battery units 100 and the buffer layers 210 included in the buffer layer supply member 200 are stacked in a zigzag stacking method to manufacture an all-solid-state secondary battery.

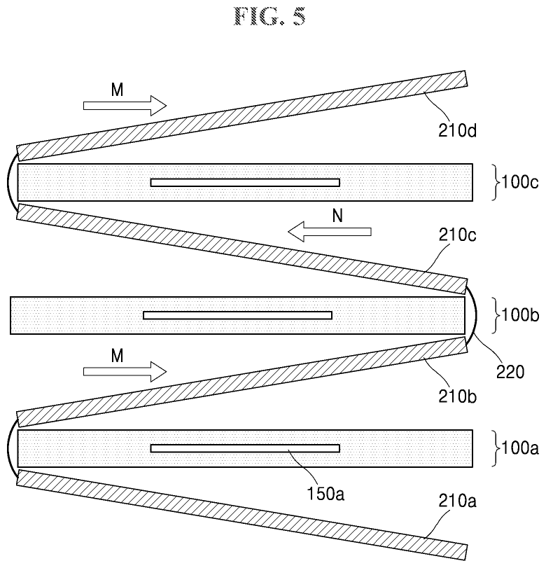

FIG. 5 is a schematic view explaining a zigzag stacking method according to an embodiment.

Referring to FIG. 5, the zigzag stacking method may be performed using a plurality of battery units 100 and a buffer layer supply member 200.

For example, in the zigzag stacking method, a first buffer layer 210a located at one end of the buffer layer 210 included in the buffer layer supply member 200. Subsequently, a first battery unit 100a may be disposed on the first buffer layer 210a. Subsequently, a portion of the buffer layer supply member 200, excluding the first buffer layer 210a, may be moved in one direction (for example, M direction) to place a second buffer layer 210b on the first battery unit 100a. Next, a second battery unit 100b may be disposed on the second buffer layer 210b. Next, a portion of the buffer layer supply member 200, excluding the first buffer layer 210a and the second buffer layer 210b, may be moved in a direction (for example, N direction) opposite to one direction to place a third buffer layer 210c on the second battery unit 100b. Subsequently, a third battery unit 100c may be disposed on the third buffer layer 210c. Next, a portion of the buffer layer supply member 200, excluding the first to third buffer layers 210a to 210c, may be moved in one direction (for example, M direction) to place a fourth buffer layer 210d on the third battery unit 100c, thereby completing a method of manufacturing an all-solid-state secondary battery 200.

For example, in the zigzag stacking method, the supplying of the buffer layer 210 and stacking of the battery units 100 by the movement of the buffer layer supply member 200 may be repeatedly performed.

According to an embodiment, an all-solid-state secondary battery may be manufactured by sealing a laminate of the buffer layer 210 and the battery unit 100 manufactured by a zigzag stacking method with an exterior material.

Although example embodiments have been described in detail with reference to the attached drawings, the present inventive concept is not limited thereto. It is obvious that anyone with ordinary knowledge in the technical field to which the present inventive concept belongs can derive various examples of changes or modifications within the scope of the technical idea described in claims, and these naturally belong to the technical scope of the present inventive concept.

### Example 1: Manufacturing of all-Solid-State Battery

An all-solid-state battery was manufactured according to the following processes.

### (Production of Cathode)

LiNi_{0.3}Co_{0.13}Mn_{0.05}O₂ (NCM) was prepared as a cathode active material. Additionally, Li₆PS₅Cl, an argyrodite type crystal, was prepared as a solid electrolyte. Additionally, polytetrafluoroethylene (Teflon binder from DuPont) was prepared as a binder. Additionally, carbon nanofibers (CNF) were prepared as a conducting agent. Then, these materials were mixed in a weight ratio of cathode active material; solid electrolyte:conducting agent:binder=85:15:3:1.5 to form a mixture, and the mixture was molded into a large sheet to produce a cathode sheet. Additionally, this cathode sheet was pressed on both sides of a cathode current collector of aluminum foil having a thickness of 18 μm to produce a cathode. The initial charge capacity (charge capacity in the first cycle) of the cathode was about 17 mAh at 4.1 V charging. The weight of the cathode was about 110 mg (about 190 mAh/g per weight of active material)

### (Solid Electrolyte)

Li₆PS₅Cl was used as a solid electrolyte.

### (Production of Solid Electrolyte/Anode Laminate)

Ni foil having a thickness of 10 μm was prepared as an anode current collector. Additionally, an NMP solution of 5 wt % of a PS-PEO-PS block copolymer (mixing weight ratio of PS-PEO-PS=12:59:12) (weight average molecular weight:about 83,000 Daltons) was added to carbon black and silver (Ag) (particle diameter 60 nm), as an anode active material, to prepare a slurry. The mixed weight ratio of carbon black and silver (Ag) is 1:3, and the content of the PS-PEO-PS block copolymer is about 5 parts by weight based on 100 parts by weight of the total weight of the anode active material (total weight of furnace black powder and silver). NMP was added until the viscosity of the slurry was suitable for film formation by a blade coater. This slurry was applied onto the solid electrolyte using a blade coater and dried in air at 80° C. for 20 minutes to prepare an anode active material layer. Additionally, the Ni foil was stacked on the anode active material layer and dried in vacuum at 100° C. for 12 hours. A solid electrolyte/anode laminate was produced through the above processes.

### (Production of Battery Unit)

A solid electrolyte/anode laminate was attached to both sides of the cathode and then sealed with a laminating film in a vacuum to produce a battery unit. Here, each part of the cathode current collector and anode current collector was protruded out of the laminating film to maintain the vacuum of a battery. These protrusions were used as cathode and anode terminals. Additionally, this all-solid-state battery was subjected to hydraulic treatment at 4 MPa for 30 minutes. The characteristics of the battery are greatly improved by performing such hydrostatic pressure treatment

### (Production of Buffer Layer Supply Member)

A carrier film was prepared. Buffer member layers containing polyurethane resin were arranged at regular intervals on both sides of the carrier film to form a buffer layer, thereby producing a buffer layer supply member. In this case, the surface of the buffer layer has a foam structure as a microstructure, and the thickness thereof was 100 μm.

(Manufacturing of all-Solid-State Secondary Battery)

An all-solid-state secondary battery was manufactured by stacking the buffer layers and the battery units using the above-described zigzag stacking method.

### Examples 2 to 8 and Comparative Examples 1 to 5

In comparison with Example 1, all-solid-state secondary batteries were manufactured in the same method as Example 1, except that the structure and components of a buffer member layer used to produce a buffer layer supply member, the microstructure of the surface of a buffer layer and the thickness of the buffer layer, and the stacking method of buffer layers and battery units were changed as shown in Table 1 below.

However, in Comparative Examples 1 to 5, one buffer member layer was stacked on the battery unit as a single buffer layer without a separate carrier film. That is, among the supply methods shown in Table 1 below, the magazine stacking method refers to a method in which the produced buffer layer and battery unit are each transported one by one and sequentially stacked without a separate carrier film.

In addition, the first layer and second layer in Table (below are sequentially stacked on the carrier film, and the first layer is disposed between the carrier film and the second layer.

TABLE 1

| | Buffer layer | | | | | |
|---|---|---|---|---|---|---|
| | Buffer member layer | | | | | |
| | | | Second | Surface | Thickness | Supply |
| | Constitution | First layer | layer | microstructure | (μm) | method |
| Example | Single | Polyurethane resin | — | Foam | 100 | Zigzag |
| 1 | layer | | | | | stacking |
| | | | | | | method |
| Example | Single | Polyurethane resin | — | Sponge | 100 | Zigzag |
| 2 | layer | | | | | stacking |
| | | | | | | method |
| Example | Single | Polyurethane resin | — | Solid | 100 | Zigzag |
| 3 | layer | | | | | stacking |
| | | | | | | method |
| Example | Single | Acrylic resin | — | Foam | 100 | Zigzag |
| 4 | layer | | | | | stacking |
| | | | | | | method |
| Example | Single | Acrylic resin | — | Sponge | 100 | Zigzag |
| 5 | layer | | | | | stacking |
| | | | | | | method |
| Example | Single | Acrylic resin | — | Solid | 100 | Zigzag |
| 6 | layer | | | | | stacking |
| | | | | | | method |
| Example | Single | Acrylic resin | — | Foam | 50 | Zigzag |
| 7 | layer | | | | | stacking |
| | | | | | | method |
| Example | Single | Acrylic resin | — | Foam | 300 | Zigzag |
| 8 | layer | | | | | stacking |
| | | | | | | method |
| Compar- | Multilayer | Silicon-based | PTFE | Sponge | 800 | Magazine |
| ative | | rubber | | | | stacking |
| Example | | | | | | method |
| 1 | | | | | | |
| Compar- | Single | Silicon-based | — | Solid | 300 | Magazine |
| ative | layer | rubber | | | | stacking |
| Example | | | | | | method |
| 2 | | | | | | |
| Compar- | Single | PTFE | — | Sponge | 500 | Magazine |
| ative | layer | | | | | stacking |
| Example | | | | | | method |
| 3 | | | | | | |
| Compar- | Single | Polyurethane resin | — | Goam | 100 | Magazine |
| ative | layer | (surface coating) | | | | stacking |
| Example | | | | | | method |
| 4 | | | | | | |
| Compar- | Single | Polyurethane resin | — | Foam | 100 | Magazine |
| ative | layer | (surface coating) | | | | stacking |
| Example | | | | | | method |
| 5 | | | | | | |

### Evaluation Example

For the manufacturing methods of the all-solid-state secondary batteries according to Examples 1 to 8 and Comparative Examples 1 to 5, stacking process difficulty and production speed were evaluated as follows. The evaluation results are listed in Table 2 below.

In addition, for the all-solid-state secondary batteries according to Examples 1 to 8 and Comparative Examples 1 to 5, charge/discharge evaluation was performed as follows to evaluate the time when a short circuit occurred. The evaluation results are listed in Table 2 below.

### (1) Evaluation of Stacking Process Difficulty

When the supply difficulty of the buffer layer according to Comparative Example 2 was set to Δ, the case where the supply difficulty of the buffer layer was improved was represented by ◯, and the case where the supply difficulty of the buffer layer was deteriorated was represented by X.

### (2) Evaluation of Production Speed

When the number of all-solid-state secondary batteries produced per unit time without using the buffer layer supply member is 10, the number of production per unit time for the manufacturing methods of the all-solid-state secondary batteries according to Examples 1 to 8 and Comparative Examples 1 to 5 was measured. The measurement results are listed in Table 2 below.

### (3) Evaluation of Short Circuit Occurrence Time

The charge/discharge characteristics of the all-solid-state secondary batteries manufactured according to Examples 1 to 8 and Comparative Examples 1 to 5 were evaluated.

In the first cycle, the battery was charged at a constant current of 0.5 mA/cm² until the battery voltage reached 4.25 V, and then charged at a constant voltage of 4.25 V until the current reached 0.2 mA. Thereafter, the battery was discharged at a constant current of 0.5 mA/cm² until the battery voltage reached 2.0 V. After the second cycle, the battery was charged at a constant current of 2.5 mA/cm² until the battery voltage reached 4.25 V, and then discharged at a current density of 2.5 mA/cm². The charge/discharge test was performed by putting the all-solid-state secondary battery into a constant temperature bath at 60° C.

While performing the charge/discharge test, the number of cycles until a short circuit occurred was measured, and the results thereof were listed in Table 2 below.

TABLE 2

| | Stacking process | | Short circuit |
|---|---|---|---|
| | difficulty | Production speed | ocorrence time |
| Example 1 | ◯ | 9 | >100 |
| Example 2 | ◯ | 8 | <50 |
| Example 3 | ◯ | 7 | <20 |
| Example 4 | ◯ | | >200 |
| Example 5 | ◯ | 8 | <80 |
| Example 6 | ◯ | 7 | <40 |
| Example 7 | ◯ | | <50 |
| Example 8 | ◯ | 3 | >300 |
| Comparative | X | | >100 |
| Example 1 | | | |
| Comparative | Δ | 3 | <50 |
| Example 2 | | | |
| Comparative | X | 3 | <50 |
| Example 3 | | | |
| Comparative | ◯ | 1 | <50 |
| Example 4 | | | |
| Comparative | ◯ | 1 | <100 |
| Example 5 | | | |

Referring to Table 2, in Examples 1 to 8 including a carrier member and using a zigzag stacking method, stacking process difficulty was decreased, and production speed was improved, compared to Comparative Examples 1 to 5 using a magazine stacking method and not including a carrier film.

In addition, referring to Examples 1 to 3, in Example 1 including a foam structure, short circuit was effectively prevented, compared to Examples 2 to 3 including a sponge structure or a solid structure. In addition, comparing Examples 1 to 3 with Examples 4 to 6, Examples 4 to 6, Examples 4 to 6 including an acrylic resin more easily implemented a short circuit prevention effect, compared to Examples 1 to 3 including a polyurethane resin.

In addition, comparing Example 1 and Examples 7 to 8, as the thickness of a buffer layer increased, a short circuit prevention effect was more easily implemented. However, compared to Example 8, in Examples 1 and 7, the thickness of the buffer layer was thinner, and thus the energy density of the all-solid-state secondary battery was further improved.

[Description of reference numerals]

| | |
|---|---|
| 10: all-solid-state secondary battery | 100: battery unit |
| 110: cathode layer | 112: cathode current collector |
| 114: cathode active material layer | 115: cathode tab |
| 120: solid electrolyte layer | 130: anode layer |
| 132: anode current collector | 134: anodeless coating layer |
| 135: anode tab | 200: buffer layer supply member |
| 205: carrier member | 210: buffer layer |
| 212: buffer member layer | 214: carrier layer |
| 220: carrier film | |

1. An all-solid-state secondary battery comprising a plurality of battery units each of which includes a cathode layer, a solid electrolyte layer, and an anode layer and which are stacked along a thickness direction;
a plurality of buffer layers each of which is disposed between the battery units adjacent to each other; and
carrier films each of which connects the buffer layers adjacent to each other.

2. The all-solid-state secondary battery of claim 1, wherein
a thickness of the carrier film is smaller than a thickness of the buffer layer.

3. The all-solid-state secondary battery of claim 1, wherein
the buffer layer has a thickness of 10 μm to 500 μm.

4. The all-solid-state secondary battery of claim 1, wherein
the buffer layer includes a polyurethane resin, an acrylic resin, a silicon-based rubber, or any combination thereof.

5. The all-solid-state secondary battery of claim 1, wherein
a surface of the buffer layer has a foam structure, a sponge structure, or a solid structure.

6. The all-solid-state secondary battery of claim 1, wherein
the carrier film connects the buffer layers in a zigzag pattern.

7. The all-solid-state secondary battery of claim 1, wherein
the buffer layer includes a buffer member layer contacting the battery unit and a carrier layer connected to the carrier film.

8. The all-solid-state secondary battery of claim 7, wherein
the buffer member layer is stacked on one side or both sides of the carrier layer.

9. The all-solid-state secondary battery of claim 7, wherein
the carrier film and the carrier layer are integrally formed.

10. The all-solid-state secondary battery of claim 7, wherein
the buffer member layer has a single-layer structure or a multi-layer structure.

11. The all-solid-state secondary battery of claim 1, wherein
a coating layer is not formed on a surface of the buffer layer.

12. The all-solid-state secondary battery of claim 1, wherein
the buffer layer is disposed to be adjacent to the anode layer of the battery unit.

13. The all-solid-state secondary battery of claim 1, wherein
the cathode layer includes a cathode current collector and a cathode active material layer disposed on one side or both sides of the cathode current collector,
the anode layer includes an anode current collector and an anode active material layer disposed on one side or both sides of the anode current collector, and
the solid electrolyte layer is disposed between the cathode layer and the anode layer.

14. The all-solid-state secondary battery of claim 13, wherein
the cathode active material layer is disposed on both sides of the cathode current collector, and
the solid electrolyte layer and the anode layer are sequentially stacked on the cathode active material layer disposed on both sides of the cathode current collector, respectively.

15. The all-solid-state secondary battery of claim 13, further comprising:
a cathode tap extending from the cathode current collector and an anode tap extending from the anode current collector,
wherein the cathode tap and the anode tap are located at a skew position with the carrier film.

16. The all-solid-state secondary battery of claim 13, wherein
the anode current collector, an anodeless coating layer, and a region therebetween are Li-free regions not including lithium (Li) in an initial state or post-discharge state of the all-solid-state secondary battery.

17. The all-solid-state secondary battery of claim 13, wherein the anode current collector, the anodeless coating layer and a region therebetween are Li-free regions including lithium (Li) in a post-discharge state of the all-solid-state secondary battery.

18. The all-solid-state secondary battery of claim 1, wherein the solid electrolyte layer includes a sulfide-based solid electrolyte.

19. A method of manufacturing an all-solid-state secondary battery, the method comprising: preparing a battery unit including an anode layer, a solid electrolyte layer, and a cathode layer;
preparing a buffer layer supply member including a plurality of buffer layers arranged in a row and a carrier film connecting the buffer layers adjacent to each other; and
sequentially stacking the battery units and the buffer layers included in the buffer layer supply member in a zigzag stacking method.

20. The method of claim 19, wherein
the buffer layer supply member includes buffer member layers disposed on one side or both sides of the carrier member at regular intervals to be spaced apart from each other.
